(19) United States
(12) Patent Application Publication
(10) Pub. No.: US 2025/0316798 A1
(43) Pub. Date: Oct. 9, 2025

(54) SECONDARY BATTERY

(71) Applicant: Samsung SDI Co., Ltd., Yongin-si (KR)

(72) Inventors: Seok Gyun Park, Yongin-si (KR); Byung Ho Lim, Yongin-si (KR); Bum Kuk Choi, Yongin-si (KR)

(73) Assignee: Samsung SDI Co., Ltd., Yongin-si (KR)

(21) Appl. No.: 18/905,367

(22) Filed: Oct. 3, 2024

(30) Foreign Application Priority Data
Apr. 4, 2024 (KR) 10-2024-0045639

(51) Int. Cl. H01M 50/105; H01M 10/04; H01M 50/119; H01M 50/121; H01M 50/124; H01M 50/136; H01M 50/178; H01M 50/186; H01M 50/193; H01M 50/198

(52) U.S. Cl. CPC H01M 50/105; H01M 10/049; H01M 50/119; H01M 50/121; H01M 50/124; H01M 50/136; H01M 50/178; H01M 50/186; H01M 50/193; H01M 50/198

(57) ABSTRACT

Disclosed is a pouch-type secondary battery having a structure for preventing occurrence of cracking in an aluminum layer of a pouch case. The secondary battery includes an electrode assembly, a pouch case including a main body and a cover, and an electrode tab portion. The pouch case includes a side sealing portion, and the side sealing portion includes a side bonding portion configured to achieve bonding between a side portion of the main body and a side portion of the cover and a side folding line configured to allow a side portion of the pouch case to be folded to an inner side of the side bonding portion. Methods of manufacturing the pouch-type secondary battery are further disclosed herein.

### CROSS-REFERENCE TO RELATED APPLICATIONS

This present application claims priority to and the benefit under 35 U.S.C. § 119(a)-(d) of Korean Patent Application No. 10-2024-0045639, filed on Apr. 4, 2024, in the Korean Intellectual Property Office, the entire disclosure of which is incorporated herein by reference.

### FIELD

The present disclosure relates to a secondary battery, and more particularly, to a pouch-type secondary battery.

### BACKGROUND

A secondary battery is a battery that is chargeable and dischargeable, unlike a primary battery that is not rechargeable. Low-capacity secondary batteries in which one battery cell is packaged in the form of a pack are used in portable small electronic devices, such as cellular phones and camcorders, and large-capacity secondary batteries in which dozens of battery cells are connected to each other in a battery pack are widely used as power sources for driving motors in hybrid vehicles and the like.

The information disclosed in this section is provided only for enhancement of understanding of the background of the disclosure and therefore it may contain information that does not form the related art.

### SUMMARY

The present disclosure provides a pouch-type secondary battery having a structure for preventing occurrence of cracking in an aluminum layer of a pouch case.

It should be noted that objects of the disclosure are not limited to the object as mentioned above, and other unmentioned objects of the disclosure will be clearly understood by those skilled in the art from the following description.

A secondary battery according to the present disclosure includes an electrode assembly, a pouch case including a main body accommodating one surface of the electrode assembly and a cover accommodating an opposite surface of the electrode assembly and coupled to the main body, and an electrode tab portion electrically connected to the electrode assembly and exposed to an outside of the pouch case, wherein the pouch case defines a cell portion configured to contain the electrode assembly therein and a sealing portion disposed on an outer periphery of the cell portion and configured to achieve sealing between the main body and the cover, the sealing portion includes a side sealing portion configured to achieve sealing between a side portion of the main body and a side portion of the cover, and the side sealing portion includes a side bonding portion configured to achieve bonding between the side portion of the main body and the side portion of the cover and a side folding line configured to allow a side portion of the pouch case to be folded to an inner side of the side bonding portion.

The side bonding portion may be an area in which an upper surface of the main body and a lower surface of the cover are in contact with each other when the cover is coupled to the main body.

The side folding line may be spaced apart from the side bonding portion by a predetermined gap.

The predetermined gap may be equal to or greater than 1/10 of the width of the cell portion and equal to or less than ⅕ of the length of the cell portion.

The gap from the side folding line to the side bonding portion may vary depending on the position of the side folding line in a folding direction.

Each of the main body and the cover may include at least a metal layer and an insulating layer formed on an inner side of the metal layer.

Each of the main body and the cover may be formed in a multilayered or laminated structure including the metal layer and the insulating layer.

The metal layer may include at least an aluminum layer, and the insulating layer may include at least a cast polypropylene (CPP) layer.

The side sealing portion may further include an adhesive layer interposed between the insulating layer of the main body and the insulating layer of the cover, the adhesive layer facing the insulating layer of the main body.

The adhesive layer may include a thermoplastic resin or a thermosetting resin.

The adhesive layer may be disposed so as to be spaced apart from the side folding line by a distance equal to or greater than 1/10 of the width of the cell portion and equal to or less than ⅕ of the length of the cell portion.

The electrode tab portion may include a first electrode tab and a second electrode tab, and the first electrode tab and the second electrode tab may extend to the outside of the pouch case.

According to some aspects, a method of manufacturing a secondary battery is provided, the method comprising: inserting an electrode assembly into a cell portion of pouch a case comprising a main body accommodating one surface of the electrode assembly and a cover accommodating an opposite surface of the electrode assembly and coupled to the main body, wherein an electrode tab portion is electrically connected to the electrode assembly and exposed to an outside of the pouch case when the electrode assembly is accommodated in the pouch case; sealing a sealing portion disposed on an outer periphery of the cell portion to seal the main body and the cover together, wherein the sealing portion comprises a side sealing portion and sealing the sealing portion comprises sealing a side portion of the main body and a side portion of the cover, and wherein the side sealing portion comprises a side bonding portion and sealing the sealing portion comprises bonding the side portion of the main body and the side portion of the cover; and folding a side portion of the pouch case along a side folding line to an inner side of the side bonding portion.

The side bonding portion may be an area in which an upper surface of the main body and a lower surface of the cover are in contact with each other when the cover is coupled to the main body.

The side folding line may be spaced apart from the side bonding portion by a predetermined gap.

The predetermined gap may be equal to or greater than 1/10 of the width of the cell portion and equal to or less than ⅕ of the length of the cell portion.

The gap from the side folding line to the side bonding portion may vary depending on the position of the side folding line in a folding direction.

Each of the main body and the cover may include at least a metal layer and an insulating layer formed on an inner side of the metal layer.

Each of the main body and the cover may be formed in a multilayered or laminated structure including the metal layer and the insulating layer.

The metal layer may include at least an aluminum layer, and the insulating layer may include at least a cast polypropylene (CPP) layer.

The side sealing portion may further include an adhesive layer interposed between the insulating layer of the main body and the insulating layer of the cover, the adhesive layer facing the insulating layer of the main body.

The adhesive layer may include a thermoplastic resin or a thermosetting resin.

The adhesive layer may be disposed so as to be spaced apart from the side folding line by a distance equal to or greater than 1/10 of the width of the cell portion and equal to or less than ⅕ of the length of the cell portion.

The electrode tab portion may include a first electrode tab and a second electrode tab, and the first electrode tab and the second electrode tab may extend to the outside of the pouch case.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a schematic perspective view showing a pouch-type secondary battery according to an embodiment of the present disclosure before sealing a pouch case;

FIG. 2 is a schematic perspective view showing the pouch-type secondary battery after sealing the pouch case shown in FIG. 1;

FIG. 3A is a top view of FIG. 2;

FIG. 3B is a top view of another embodiment of FIG. 3A;

FIG. 4 is a top view of a main body of the pouch case according to an embodiment of the present disclosure;

FIG. 5 is a cross-sectional view of the pouch case according to an embodiment of the present disclosure;

FIG. 6A is a picture showing test results obtained from a secondary battery in which a cell portion area (C1) has a size of 40 mm×50 mm×70 mm (thickness×width×length) and a gap between a side folding line and a side bonding portion is 0.6 mm;

FIG. 6B is a picture showing test results obtained from a secondary battery in which the cell portion area (C1) has a size of 40 mm×50 mm×70 mm (thickness×width×length) and a gap between a side folding line and a side bonding portion is 0.7 mm; and

FIG. 7 illustrates a cross-sectional view of the pouch case in which adhesive layers are additionally provided and an enlarged view showing the adhesive layers in detail.

### DETAILED DESCRIPTION

Hereinafter, preferred embodiments of the present disclosure will be described in detail with reference to the accompanying drawings. It should be understood that the terms or words used in the specification and appended claims should not be construed as being limited to general and dictionary meanings, but should be construed based on meanings and concepts according to the technical idea of the disclosure on the basis of the principle that the inventor is permitted to define appropriate terms for the best explanation. Embodiments described in this specification and constructions shown in the drawings are merely the most preferred embodiments and do not speak for the entirety of the technical idea of the disclosure, and therefore it should be understood that various replaceable equivalents and modifications may be possible at the time of filing the present application.

As used herein, the terms “comprise” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups thereof.

The accompanying drawings may not be to scale and some components may be exaggerated in dimensions in order to facilitate understanding of the disclosure. In different embodiments, the same components may be denoted by the same reference numerals.

A reference to two comparables being “identical” means that they are “substantially identical.” Thus, substantially the same may include deviations that are considered low in the art, such as deviations of less than 5%. If a parameter is uniform in a given region, this may mean that the parameter is uniform from an average perspective.

Although first, second, and the like are used to describe various components, the components are not limited by these terms. These terms are used only to distinguish one component from another, and a first component may be a second component unless otherwise noted.

Throughout the specification, each component may be singular or plural unless otherwise indicated.

If any configuration is disposed “above” (or “below”) a component or “on” (or “under”) the component, this may mean not only that the configuration is disposed abutting an upper surface (or a lower surface) of the component, but that another configuration may be interposed between the component and the configuration disposed on (or under) the component.

It should also be understood that, if a component is described as being “connected,” “coupled,” or “linked” to another component, the components may be directly connected or linked to each other, another component may be “interposed” between other components, or the components may be “connected,” “coupled,” or “linked” to each other via another component. When one element is referred to as being electrically coupled to another element, the element may be directly coupled to the other element or indirectly coupled to the other element via one or more intervening elements.

Throughout the specification, references to “A and/or B” mean A, B, or A and B, unless otherwise indicated. The term “and/or” refers to all combinations or an arbitrary combination of a plurality of related listed items. References to “C to D” mean C or higher and D or lower, unless otherwise indicated.

The terms used in the specification are intended to describe specific embodiments of the disclosure and are not intended to limit the disclosure.

Secondary batteries, as described herein, may include an electrode assembly including a positive electrode and a negative electrode, a case accommodating the electrode assembly, and an electrode terminal connected to the electrode assembly. Secondary batteries may be classified into a cylindrical type, a prismatic type, and a pouch type depending on the shape thereof.

The pouch-type secondary battery may include a pouch case that is easily formed in any of various shapes and is relatively lightweight.

In the case of a pouch-type secondary battery, a sealing portion and a folding line overlap each other along an edge of a pouch case. Thus, when stretching processing is performed on the pouch case, stress caused by movement of an electrode assembly is concentrated on the edge of the pouch case, and thus cracking frequently occurs in an aluminum layer of the pouch case.

Embodiments of the present disclosure provide a pouch-type secondary battery having a structure for preventing occurrence of cracking in an aluminum layer of a pouch case.

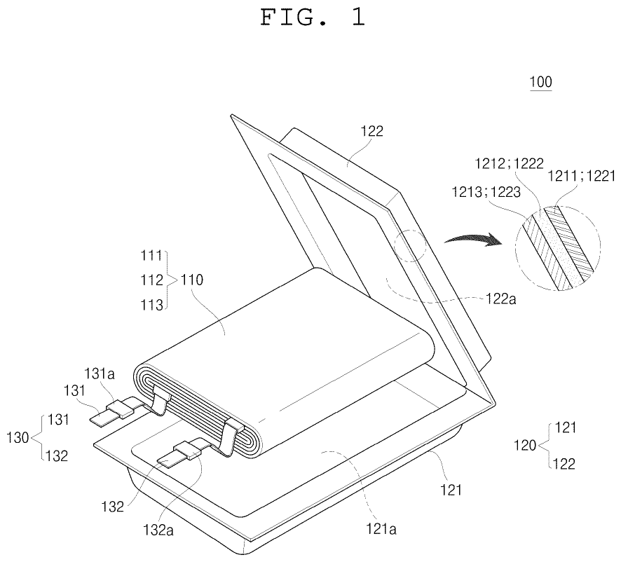

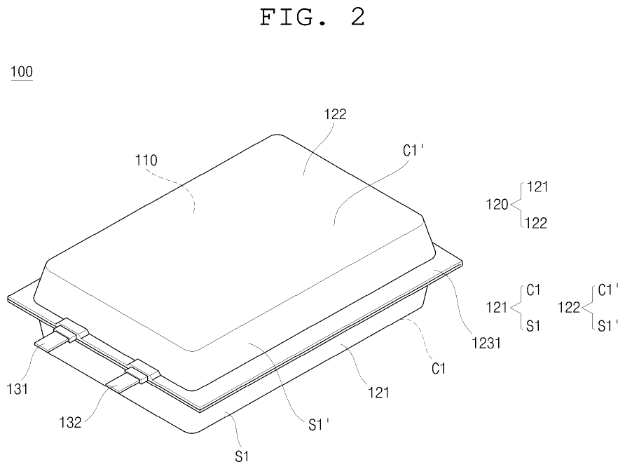

FIG. 1 shows a pouch-type secondary battery 100 according to an embodiment of the present disclosure before folding and sealing a pouch case, and FIG. 2 shows the pouch-type secondary battery 100 after sealing the pouch case shown in FIG. 1.

Referring to FIGS. 1 and 2, the secondary battery 100 may include an electrode assembly 110, a pouch case 120, and an electrode tab portion 130.

The electrode assembly 110 may include a negative electrode plate 111, a positive electrode plate 112, and a separator 113 interposed between the negative electrode plate 111 and the positive electrode plate 112. The electrode assembly 110 may be configured such that the negative electrode plate 111, the separator 113, and the positive electrode plate 112 are stacked or wound in a jellyroll shape. In some embodiments, the electrode assembly may be accommodated in the pouch case together with an electrolyte.

The negative electrode plate 111 may include a negative electrode active material layer coated on both surfaces of a negative electrode current collector formed as a conductive metal thin plate, e.g., a copper or nickel foil or mesh. However, the disclosure is not limited thereto. The negative electrode active material layer may include, for example, a carbon-based material, Si, Sn, tin oxide, a tin alloy composite, a transition metal oxide, lithium metal nitrite, or a metal oxide. However, the disclosure is not limited thereto. For example, a substantially flat negative electrode tab 131 may be fixed (e. g., welded) to a negative electrode uncoated portion of the negative electrode current collector, not provided with the negative electrode active material layer. However, the disclosure is not limited thereto. For example, one end of the negative electrode tab 131 may be electrically connected to the negative electrode uncoated portion, and the other end thereof may protrude and extend to the outside. In some embodiments, an insulating member 131a may be attached to the negative electrode tab 131 to prevent a short circuit between the negative electrode tab 131 and the pouch case.

The positive electrode plate 112 may include a positive electrode active material layer coated on both surfaces of a positive electrode current collector formed as a highly conductive metal thin plate, e.g., an aluminum foil or mesh. However, the disclosure is not limited thereto. The positive electrode active material layer may include, for example, a chalcogenide compound, e.g., a composite metal oxide such as LiCoO₂, LiMn₂O₄, LiNiO₂, or LiNiMnO₂. However, the disclosure is not limited thereto. For example, a positive electrode tab 132 may be fixed (e.g., welded) to a positive electrode uncoated portion of the positive electrode current collector, not provided with the positive electrode active material layer. However, the disclosure is not limited thereto. In some embodiments, an insulating member 132a may be attached to the positive electrode tab 132 to prevent a short circuit between the positive electrode tab 132 and the pouch case.

The separator 113 may be interposed between the negative electrode plate 111 and the positive electrode plate 112 to prevent a short circuit between the negative electrode plate and the positive electrode plate. The separator 113 may be provided in a pair, and the negative electrode plate 111 may be disposed to be held between the pair of separators 113. In some embodiments, the separator 113 may be made of a material selected from the group consisting of, for example, polyethylene, polypropylene, and a porous copolymer of polyethylene and polypropylene. However, the disclosure is not limited thereto. The separator 113 may be formed to have a larger width than the negative electrode plate 111 and the positive electrode plate 112 in order to prevent a short circuit between the negative electrode plate 111 and the positive electrode plate 112.

The electrode tab portion 130 may include a negative electrode tab 131 and a positive electrode tab 132. The negative electrode tab 131 may be located on the left end of one surface of the electrode assembly, and the positive electrode tab 132 may be located on the right end of the surface of the electrode assembly. The electrode tab portion 130 may extend outwards to the outside of the pouch case through an area of the pouch case in which a main body of the pouch case and a cover of the pouch case are fused to each other. Insulating members 131a and 132a formed on the negative electrode tab 131 and the positive electrode tab 132 may be sealed together by a sealing portion 123. For example, the insulating s 131a and 132a may be formed on portions of the negative electrode tab 131 and the positive electrode tab 132 that are in contact with the sealing portion 123, thereby preventing a short circuit between the negative electrode and positive electrode tabs 131 and 132 and the pouch case 120.

The pouch case 120 may be formed so as to accommodate the electrode assembly 110 and to seal the outer peripheral surface of the electrode assembly 110. The pouch case 120 may substantially include a main body 121, which accommodates one surface of the electrode assembly, and cover 122, which accommodates the opposite surface of the electrode assembly. The main body 121 may include a main body recess 121a formed therein to accommodate one surface 110a of the electrode assembly and a portion 110b of a side surface connected to the surface 110a, and the cover 122 may include a cover recess 122a formed therein to accommodate the opposite surface 110c of the electrode assembly and a portion 110d of the side surface connected to the opposite surface 110c. In other embodiments, only one of the main body recess 121a and the cover recess 122a may be formed taking into consideration the required function or form of the secondary battery.

The main body 121 may include, for example, at least a metal layer 1211 and an insulating layer 1212 formed on an inner side of the metal layer, and the cover 122 may include, for example, at least a metal layer 1221 and an insulating layer 1222 formed on an inner side of the metal layer. However, the disclosure is not limited thereto. In one example, the metal layers 1211 and 1221 may be aluminum layers, and the insulating layers 1212 and 1222 formed on the inner sides of the metal layers may be cast polypropylene layers. However, the disclosure is not limited thereto. In other embodiments, the main body 121 may further include an additional insulating layer 1213 formed on an outer side of the metal layer 1211, and the cover 122 may further include an additional insulating layer 1223 formed on an outer side of the metal layer 1221. Identical to the insulating layers disposed on the inner sides of the aluminum layers, the additional insulating layers may also be cast polypropylene layers. However, the disclosure is not limited thereto. In this way, the pouch case constituted by the main body and the cover may be formed in a multilayered or laminated structure including the insulating layer and the metal layer. In other embodiments, various adhesive layers or functional layers may be additionally included. However, a detailed description thereof will be omitted for convenience of description.

For example, thermal fusion may be performed on the edge of the main body 121 and the edge of the cover 122 in order to bond the main body 121 and the cover 122 to each other. However, the disclosure is not limited thereto. Thus, as shown in FIG. 2, the electrode assembly 110 may be sealed in the pouch-type or pocket-type pouch case. In order to divide the pouch case 120 into the main body and the cover, an integrated rectangular plate-shaped pouch exterior material may be bent at a substantially middle portion thereof in the longitudinal direction thereof. Further, press or drawing processing may be performed on at least one of the main body or the cover so that the main body recess 121a and/or the cover recess 122a is formed to a predetermined depth so as to accommodate the electrode assembly 110 therein.

The main body 121 of the pouch case 120 may include a cell portion area C1 formed to contain the electrode assembly therein and a sealing portion area S1 formed on the outer periphery of the cell portion area C1 to achieve sealing between the main body and the cover, and the cover 122 of the pouch case 120 may include a cell portion area C1′ formed to contain the electrode assembly therein and a sealing portion area S1′ formed on the outer periphery of the cell portion area C1′ to achieve sealing between the main body and the cover. Thus, the pouch case 120 sealing the electrode assembly may be structured such that the cell portion area C1 of the main body 121 and the cell portion area C1′ of the cover 122 face each other and the sealing portion area S1 of the main body 121 and the sealing portion area S′ of the cover 122 face each other.

In one example, each of the sealing portion areas S1 and S1′, which are side surfaces of the main body 121 and the cover 122, may include a side sealing portion 1231 formed so as to seal the non-exposed portions of the negative electrode tab 131 and the positive electrode tab 132. The side sealing portion 1231 may be formed substantially parallel to the side surface of the electrode assembly 110.

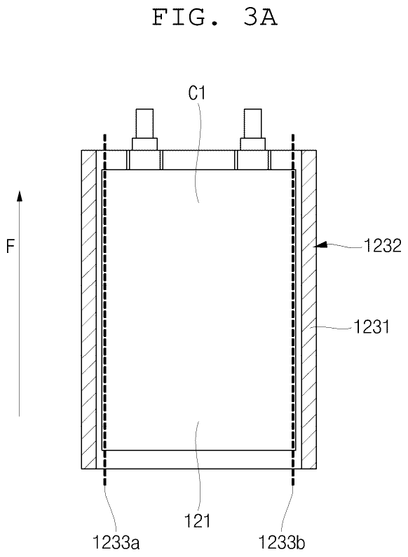

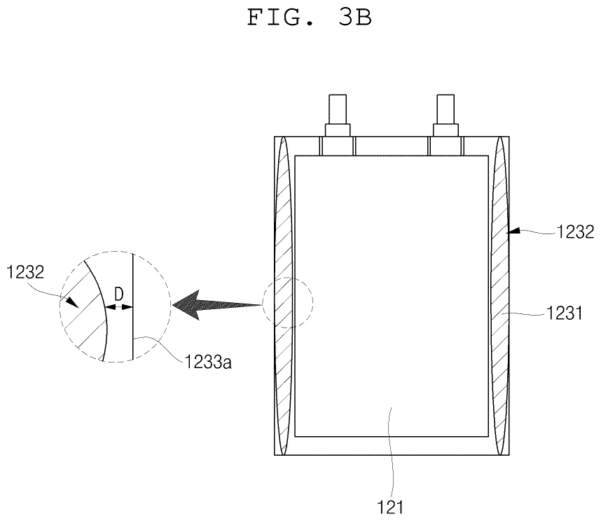

FIGS. 3A and 3B show only the main body 121 of the pouch case with the cover 122 of the pouch case removed in order to explain the side sealing portion 1231 in more detail.

Although a detailed description and illustration of the cover of the pouch case are omitted, the description of the main body of the pouch case may also be applied to the cover of the pouch case without departing from the scope and spirit of the present disclosure.

Referring to FIGS. 3A and 3B, the boundary of the cell portion area C1 of the main body 121 may be determined by folding lines 1233a and 1233b disposed substantially parallel to each other and extending in a folding direction F of the pouch case. Both sides of the cell portion area C1 located outside the side folding lines 1233a and 1233b may be defined as the side sealing portion 1231.

Further, the side sealing portion 1231 may include a side bonding portion 1232 in which the side portion of the main body and the side portion of the cover are bonded to each other. FIG. 3A shows a case in which the side bonding portion 1232 is formed to have a substantially uniform width in one direction, and FIG. 3B shows a case in which the side bonding portion 1232 is formed such that the width thereof varies in one direction, i.e., depending on the position thereof. The term “side bonding portion” used in this specification refers to an area in which the insulating layer of the side portion of the main body and the insulating layer of the side portion of the cover are bonded to each other, for example, through thermal fusion and/or stretching processing. A predetermined gap between two components refers to the shortest distance between the two components. For example, in FIG. 3B, a gap between the side bonding portion and the side folding line may be understood as “D”.

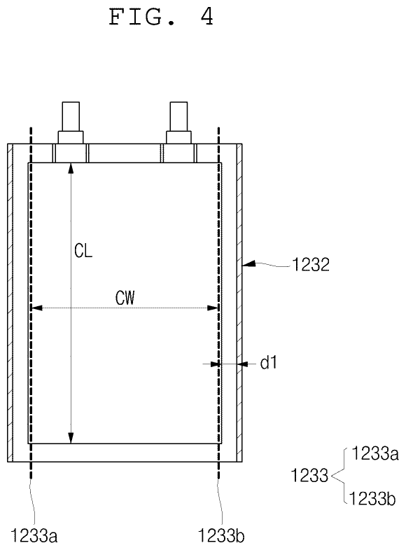

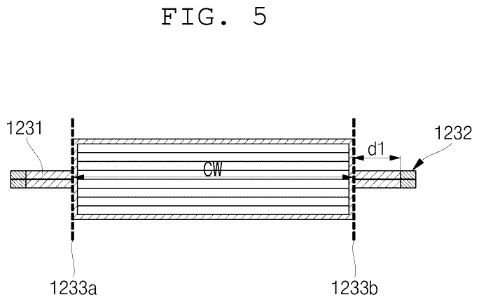

FIGS. 4 and 5 are, respectively, a top view of the main body and a cross-sectional view of the pouch case. For convenience of description, FIGS. 4 and 5 show the side sealing portion including the side folding lines corresponding to the case in which the side bonding portion has a uniform width in the folding direction. The substantial width of the cell portion area C1 containing the electrode assembly therein may be determined by the side folding lines 1233a and 1233b disposed substantially parallel to each other.

In this case, the side bonding portion 1232 may be disposed so as to be spaced apart from the side folding line 1233 by a predetermined gap d1.

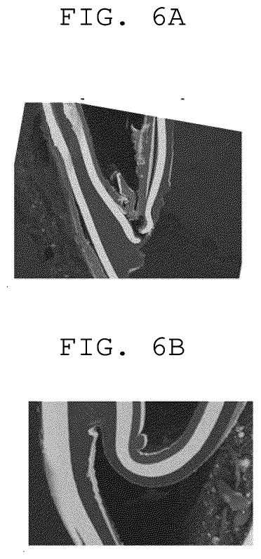

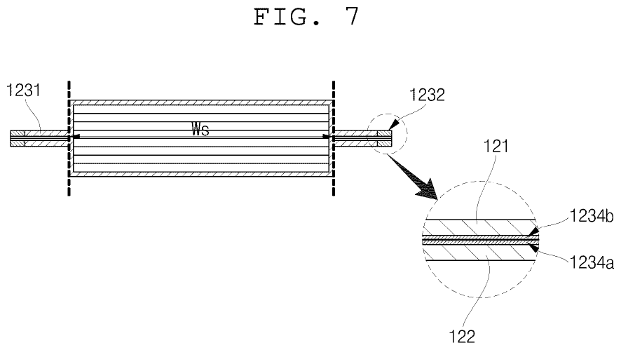

For example, the gap d1 may be equal to or greater than 1/10 of a width CW of the cell portion area C1 and equal to or less than ⅕ of a length CL of the cell portion area C1. If the gap d1 is less than 1/10 of the width CW of the cell portion area C1, i.e., if the folding line is set to be very close to the side bonding portion, stress caused by movement of the jellyroll-type electrode assembly is highly likely to be concentrated on the side bonding portion due to a very small gap between the folding line and the side bonding portion during a manufacturing process or use. If the pouch case is folded at a position adjacent to the insulating layer (e.g., cast polypropylene (CPP) layer) of the side bonding portion pushed during sealing, the metal layer (e.g., aluminum layer) of the main body and/or cover of the pouch case may be stretched. Further, as shown in FIG. 6A, the metal layer of the pouch case may be broken due to movement of the jellyroll-type electrode assembly in the pouch case, resulting in tearing of the side sealing portion, which may result in a problem of leakage of an electrolyte.

FIG. 6A shows a test result obtained from a secondary battery in which the cell portion area C1 has a size of 40 mm×50 mm×70 mm (thickness×width×length) and the gap d1 is 0.6 mm. It may be seen from FIG. 6A that, when the pouch case is sealed, the CPP layer is pushed toward the side folding line, and the aluminum layer is stretched and is, as a result, broken due to movement of the electrode assembly in the pouch case. This defect may cause leakage of an electrolyte in the secondary battery.

FIG. 6B shows a test result obtained from a secondary battery in which the cell portion area C1 has a size of 40 mm×50 mm×70 mm (thickness×width×length) and the gap d1 is 0.7 mm. It may be seen from FIG. 6B that cracking of the aluminum layer of the pouch case is effectively prevented by setting the gap between the side bonding portion and the folding line to 0.7 mm or greater. In this case, because the CPP portion of the side bonding portion does not overlap the folding line, the pouch case may be prevented from being damaged during stretching processing thereof.

FIG. 7 schematically shows a case in which adhesive layers 1234a and 1234b are additionally interposed in the side sealing portion between the upper surface of the main body 121 and the lower surface of the cover 122. The adhesive layers may include, for example, a thermoplastic resin or a thermosetting resin containing an inorganic filler (e.g., silica, alumina, or boehmite). However, the disclosure is not limited thereto.

Similar to the above-described side bonding portion 1232, the adhesive layers may also be disposed so as to be spaced apart from the side folding line by a distance equal to or greater than 1/10 of a width Ws of the cell portion area C1 and equal to or less than ⅕ of a length Lt of the cell portion area C1.

The thermal melting temperature (i.e., thermal curing temperature) of the adhesive may be, for example, about 100° C. to about 200° C. However, the disclosure is not limited thereto. Taking into consideration that the thermal fusion temperature of cast polypropylene (CPP) is 180° C. to 200° C. in the absence of an adhesive, the thermal melting temperature of the adhesive needs to be controlled to be lower than the thermal fusion temperature of the CPP layer of the pouch case.

According to the above-described pouch-type secondary battery of the present disclosure, because the aluminum layer of the pouch case is prevented from cracking, leakage of an electrolyte due to tearing of the side sealing portion in the secondary battery may be prevented.

As is apparent from the above description, according to the present disclosure, cracking of an aluminum layer of a pouch case may be prevented. As a result, it may be possible to prevent leakage of an electrolyte due to tearing of a side sealing portion in a pouch-type secondary battery.

According to some aspects, a method of manufacturing a secondary battery is provided, the method comprising: inserting an electrode assembly into a cell portion of a pouch case comprising a main body accommodating one surface of the electrode assembly and a cover accommodating an opposite surface of the electrode assembly coupled to the main body, wherein an electrode tab portion is electrically connected to the electrode assembly and exposed to an outside of the pouch case when the electrode assembly is accommodated in the pouch case; sealing a sealing portion disposed on an outer periphery of the cell portion to seal the main body and the cover together, wherein the sealing portion comprises a side sealing portion and sealing the sealing portion comprises sealing a side portion of the main body and a side portion of the cover, and wherein the side sealing portion comprises a side bonding portion and sealing the sealing portion comprises bonding the side portion of the main body and the side portion of the cover; and folding a side portion of the pouch case along a side folding line to an inner side of the side bonding portion.

The side bonding portion may be an area in which an upper surface of the main body and a lower surface of the cover are in contact with each other when the cover is coupled to the main body.

The side folding line may be spaced apart from the side bonding portion by a predetermined gap.

The predetermined gap may be equal to or greater than 1/10 of the width of the cell portion and equal to or less than ⅕ of the length of the cell portion.

The gap from the side folding line to the side bonding portion may vary depending on the position of the side folding line in a folding direction.

Each of the main body and the cover may include at least a metal layer and an insulating layer formed on an inner side of the metal layer.

Each of the main body and the cover may be formed in a multilayered or laminated structure including the metal layer and the insulating layer.

The metal layer may include at least an aluminum layer, and the insulating layer may include at least a cast polypropylene (CPP) layer.

The side sealing portion may further include an adhesive layer interposed between the insulating layer of the main body and the insulating layer of the cover, the adhesive layer facing the insulating layer of the main body.

The adhesive layer may include a thermoplastic resin or a thermosetting resin.

The adhesive layer may be disposed so as to be spaced apart from the side folding line by a distance equal to or greater than 1/10 of the width of the cell portion and equal to or less than ⅕ of the length of the cell portion.

The electrode tab portion may include a first electrode tab and a second electrode tab, and the first electrode tab and the second electrode tab may extend to the outside of the pouch case.

The effects of the disclosure are not limited to those described above, and other unmentioned technical effects will be apparent to those skilled in the art from the above description of exemplary embodiments.

While the disclosure has been hereinabove described in connection with only a limited number of embodiments and drawings, the disclosure is not limited thereto and it should be understood that various changes and modifications may be made by those skilled in the art within the spirit and scope of the disclosure and the appended claims and their equivalents.

What is claimed is:

1. A secondary battery comprising:
an electrode assembly;
a pouch case comprising a main body accommodating one surface of the electrode assembly and a cover accommodating an opposite surface of the electrode assembly and coupled to the main body; and
an electrode tab portion electrically connected to the electrode assembly and exposed to an outside of the pouch case,
wherein the pouch case defines a cell portion configured to contain the electrode assembly therein and a sealing portion disposed on an outer periphery of the cell portion and configured to achieve sealing between the main body and the cover,
wherein the sealing portion comprises a side sealing portion configured to achieve sealing between a side portion of the main body and a side portion of the cover, and
wherein the side sealing portion comprises a side bonding portion configured to achieve bonding between the side portion of the main body and the side portion of the cover and a side folding line configured to allow a side portion of the pouch case to be folded to an inner side of the side bonding portion.

2. The secondary battery as claimed in claim 1, wherein the side bonding portion is an area in which an upper surface of the main body and a lower surface of the cover are in contact with each other when the cover is coupled to the main body.

3. The secondary battery as claimed in claim 1, wherein the side folding line is spaced apart from the side bonding portion by a predetermined gap.

4. The secondary battery as claimed in claim 3, wherein the predetermined gap is equal to or greater than 1/10 of a width of the cell portion and equal to or less than ⅕ of a length of the cell portion.

5. The secondary battery as claimed in claim 1, wherein a gap from the side folding line to the side bonding portion varies depending on a position of the side folding line in a folding direction.

6. The secondary battery as claimed in claim 1, wherein each of the main body and the cover comprises at least a metal layer and an insulating layer formed on an inner side of the metal layer.

7. The secondary battery as claimed in claim 6, wherein each of the main body and the cover is formed in a multilayered or laminated structure comprising the metal layer and the insulating layer.

8. The secondary battery as claimed in claim 6 wherein the metal layer comprises at least an aluminum layer, and
wherein the insulating layer comprises at least a cast polypropylene (CPP) layer.

9. The secondary battery as claimed in claim 6, wherein the side sealing portion further comprises an adhesive layer interposed between the insulating layer of the main body and the insulating layer of the cover, wherein the adhesive layer faces the insulating layer of the main body.

10. The secondary battery as claimed in claim 9, wherein the adhesive layer comprises a thermoplastic resin or a thermosetting resin.

11. The secondary battery as claimed in claim 10, wherein the adhesive layer is disposed so as to be spaced apart from the side folding line by a distance equal to or greater than 1/10 of a width of the cell portion and equal to or less than ⅕ of a length of the cell portion.

12. The secondary battery as claimed in claim 1, wherein the electrode tab portion comprises a first electrode tab and a second electrode tab, and
wherein the first electrode tab and the second electrode tab extend to the outside of the pouch case.

13. A method of manufacturing a secondary battery, the method comprising:
inserting an electrode assembly into a cell portion of a pouch case comprising a main body accommodating one surface of the electrode assembly and a cover accommodating an opposite surface of the electrode assembly and coupled to the main body, wherein an electrode tab portion is electrically connected to the electrode assembly and exposed to an outside of the pouch case when the electrode assembly is accommodated in the pouch case;
sealing a sealing portion disposed on an outer periphery of the cell portion to seal the main body and the cover together,
wherein the sealing portion comprises a side sealing portion and sealing the sealing portion comprises sealing a side portion of the main body and a side portion of the cover, and
wherein the side sealing portion comprises a side bonding portion and sealing the sealing portion comprises bonding the side portion of the main body and the side portion of the cover; and
folding a side portion of the pouch case along a side folding line to an inner side of the side bonding portion.

14. The method as claimed in claim 13, wherein the side bonding portion is an area in which an upper surface of the main body and a lower surface of the cover are in contact with each other when the cover is coupled to the main body.

15. The method as claimed in claim 13, wherein the side folding line is spaced apart from the side bonding portion by a predetermined gap.

16. The method as claimed in claim 15, wherein the predetermined gap is equal to or greater than 1/10 of a width of the cell portion and equal to or less than ⅕ of a length of the cell portion.

17. The method as claimed in claim 13, wherein a gap from the side folding line to the side bonding portion varies depending on a position of the side folding line in a folding direction.

18. The method as claimed in claim 13, wherein each of the main body and the cover comprises at least a metal layer and an insulating layer formed on an inner side of the metal layer.

19. The method as claimed in claim 18, wherein each of the main body and the cover is formed in a multilayered or laminated structure comprising the metal layer and the insulating layer.

20. The method as claimed in claim 18, wherein the metal layer comprises at least an aluminum layer, and
wherein the insulating layer comprises at least a cast polypropylene (CPP) layer.
